(19) United States
(12) Patent Application Publication
(10) Pub. No.: US 2002/0030326 A1
(43) Pub. Date: Mar. 14, 2002

(54) "FLAME RESISTANT PIPE FLANGE GASKET"

(76) Inventor: ALAN C. BETTENCOURT, SOLANO BEACH, CA (US)

Correspondence Address: JOHN A MOLNAR JR, PARKER-HANNIFIN CORPORATION, 6035 PARKLAND BOULEVARD, CLEVELAND, OH, 44124-4141, US

(21) Appl. No.: 09/193,451

(22) Filed: Nov. 17, 1998

Related U.S. Application Data
(60) Provisional application No. 60/067,595, filed on Dec. 5, 1997.

(51) Int. Cl. H02G 15/013

(52) U.S. Cl. 277/602

(57) ABSTRACT

A flame resistant gasket for interposition between the interface surfaces of a pair of mating pipe flanges. The gasket includes a metal retainer member having generally planar first and second surfaces with at least one aperture formed therethrough which is configured for generally coaxial registration with a fluid passageway defined through the pipe flanges. At least one generally annular, flame resistant outer seal member is supported on the retainer member as disposed coaxially with the aperture thereof a spaced-apart, radially outward distance therefrom. The outer seal member has oppositely-disposed first and second outer radial sealing surfaces for abutting contact with a corresponding one of the interfaces surfaces, and is compressible axially between the interface surfaces for effecting a first fluid-tight seal about the fluid passageway. At least one generally annular, elastomeric inner seal member optionally is attached to the retainer member as disposed coaxially with the aperture thereof radially inwardly of the outer seal member. The inner seal member has oppositely-disposed first and second inner radial sealing surfaces for abutting contact with a corresponding one of the interfaces surfaces, and is compressible axially between the interface surfaces for effecting a second fluid-tight seal about the fluid passageway.

### RELATED CASES

The present application claims priority to U.S. Provisional Application Ser. No. 60/067,595; filed Dec. 5, 1997.

### BACKGROUND OF THE INVENTION

The present invention relates broadly to a sealing assembly or gasket adapted to provide a fluid seal intermediate a mating pair of pipe flanges, and more particularly to a composite, flame resistant pipe flange gasket construction incorporating one or more outer flame resistant seal members and, optionally, one or more inner elastomeric seal members, both such members being supported on a metal retainer member.

Sealing gaskets of the type herein involved are employed in a variety of commercial and industrial fluid transport applications for compression between the opposing or faying surfaces of a pair of mating pipe flange ends to provide a fluid-tight interface sealing thereof. In basic construction, such gaskets are typically are formed of a relatively compressible, annular seal member having a central aperture configured for registration with the corresponding fluid passageways of the pipes. The seal member optionally may be received in a generally planar, metal retainer.

In use, the gasket is clamped between the mating, generally annular pipe flanges to effect the compression and deformation of the seal member developing a fluid-tight interface with each of the faying surfaces of the pipe flanges. Typically, the compressive force is supplied using a circumferentially spaced-apart arrangement of bolts or other fastening members, each of which is received through an indexed pair of throughbores formed within the flanges. Depending upon the geometry of the gasket, the fastening members also may index through corresponding apertures formed within the seal or retainer member of the gasket.

A representative pipe flange gasket is disclosed in Glasgow, U.S. Pat. No. 3,302,953. The gasket includes an outer metal ring portion having a plurality of peripherally-spaced bolt hole apertures and a central fluid passageway. A pair of diverging, annular sealing lip portions are provided to extend inwardly from the innermost edge of the outer ring portion to form an inwardly-facing annular groove. A resilient sealing ring formed of a synthetic rubber material or the like is molded within the groove to provide a low pressure seal. As interposed between a pair of pipe flanges, the sealing lip portions of the outer ring are compressed to provide a high pressure seal and to prevent the extrusion of the resilient sealing ring.

Meyers, U.S. Pat. No. 3,841,953, discloses a composite cylinder head gasket for an internal combustion engine which includes a metal sheet. On either side of the metal sheet is coated a layer of a sealant. The sealant is preferably formed of a laminated graphite sheet or foil having a density which is substantially less than its fully compressed density. Upon the installation of the gasket between opposing surfaces of the cylinder head and block of the engine, the tightening of the head bolts to a desired torque compresses the gasket such that portions of the graphite material are compressed to a maximum density.

Dinger, U.S. Pat. No. 3,942,807, discloses a sealing arrangement between a cylinder crankcase and a cylinder head. A seal for the arrangement is constructed as having an outer flat metal portion to which is bonded an inner elastic seal ring or liner of a vulcanized rubber or the like.

Sugawara, U.S. Pat. No. 4,243,231, discloses a cylinder head gasket which includes a base sheet having a plurality of holes with a cut-out area adjoining the holes. Within the cut-out area is mounted a graphite sheet which is described to resist deterioration within the narrow area between the adjoining holes.

Kanczarek, U.S. Pat. No. 4,690,438, discloses a gasket construction including an incompressible base portion formed of a pair of concentric rings having a slot therebetween. Within the slot is disposed a soft-material insert formed of expanded graphite.

Kawata et al., U.S. Pat. No. 4,756,561, disclose a gasket for use between connecting flanges in exhaust system of an engine. The gasket is constructed of a pair of thin metal sheets between which is interposed an intermediate layer formed of a blend of ceramic fibers and a thermally-expandable filler material such mica or vermiculite particles. A gas passage aperture is formed through the center of the gasket, with bolt holes being formed on opposite sides thereof. An annular metal insert member optionally may be provided about the bolt holes to support the bolt tightening forces such that the bolts may be torqued without developing excessive pressure on the intermediate layer. In operation within the engine, the heat transported with the exhaust gas effects a thickness expansion of the intermediate layer, which expansion is relieved as the intermediate layer contracts upon cooling.

Dennys, U.S. Pat. No. 5,222,744, discloses a sealing gasket for a flanged pipe coupling which includes a packing of expanded graphite disposed between an inner and outer metal reinforcement rings. The two rings are oriented on different planes prior to clamping between the pipe flanges, with the graphite packing being made to be applied against the bearing surfaces of the flanges. As the flanges are clamped, opposing forces are developed which effect the compression of the packing.

Latty, U.S. Pat. No. 5,413,359, discloses a gasket which includes an inner annular metal core, and an outer compressible ring of an expanded graphite material. The metal core has a circular recess on an outer circumference thereof which is provided in the form of a V-shaped trough. The gasket ring is inserted in the recess in alignment with the core.

Borneby, U.S. Pat. No. 5,531,454, discloses a laminated cylinder head gasket. The laminate is formed of an inner layer of a metal plate interposed between outer layers of an expandable graphite material. The graphite material is a mixture of expanded and unexpanded graphite which, upon heating, expands to create an outward pressure that is stated to improve the sealing ability of the gasket.

Kestley et al., U.S. Pat. No. 5,558,344 describe an exhaust pipe flange gasket which includes a metal retainer having an integral shielding grommet defining the outer periphery of the aperture of the gasket. A sealing element is retained within the grommet.

Mann, U.S. Pat. No. 5,518,280 and International Appln. No. WO 96/31724, describes an exhaust pipe gasket including an inner annular sealing ring member constructed of a deformable material, such as non-asbestos fibers admixed with steel wire, and an outer spacer or retainer ring preferably is constructed of steel.

Cobb, U.S. Pat. No. 4,676,515 discloses an exhaust manifold gasket formed of two embossed metallic layers and an intermediate compressed expanded graphite layer.

Bain et al., U.S. Pat. No. 3,635,480, and Jelinek, U.S. Pat. No. 3,578,346, disclose pipe flange gaskets which comprise a metal plate or retainer embedded in a resilient member.

Papenguth, U.S. Pat. No. 3,215,442 discloses a composite metal and rubber sealing ring. The metal portion is provided as having a pair of flexible lips which form a groove for receiving the rubber ring.

Fujisawa et al., U.S. Pat. No. 4,802,698, disclose a pipe flange gasket formed by wrapping a thin metal sheet around a heat resistant material.

Nerenberg, U.S. Pat. No. 5,333,919, discloses a pipe joint formed between a pair of annular pipe flanges. The joint includes a gasket which is formed as a ring having recessed surfaces around the inner diameter thereof. The recessed surfaces are filled with a sealant material for compression within the finished joint.

Jackson, U.S. Pat. No. 2,513,178 discloses a bolted flange connection including a gasket. The gasket is formed as an annular member having a rectangular groove on each side within which is positioned a sealing ring of a triangular cross-section.

Glynn, U.S. Pat. No. 3,737,169, discloses the application of a deformable elastomeric bead material to a localized area of at least one surface of a base material to form a pipe flange gasket. The bead, which is of a semi-circular cross-section and cured to form a resilient seal, is secured to one face surface of the base as applied from a nozzle in a closed loop around a port or aperture of the base material.

Ahlstone, U.S. Pat. Nos. 4,294,477 and 4,272,109, discloses a ring gasket having peripheral, oppositely-tapered sealing surfaces. The surfaces are disposable in a sealing arrangement between grooves formed within a mating pair of pipe flanges.

Coker, U.S. Pat. No. 3,871,668 discloses a seal for insertion between opposed flanges of vacuum equipment. The seal includes a carrier ring having a T-shaped recess groove extending peripherally about the inner diameter thereof. A sealing ring is received within the groove.

Doyle, U.S. Pat. No. 4,519,619 discloses a high temperature resistant gasket including a central annular core, and first and second sheet members having embossments defining concave recesses that face the core. A high temperature resistant filler material, which may be an expanded graphite foil, is disposed within each of the recesses.

Aichroth, U.S. Pat. No. 3,167,322 discloses a seal which includes an O-ring mounted between an inner and outer retainer.

Moyers, U.S. Pat. No. 3,195,906 disclose a composite sealing ring having a compression stop for use in sealing pipe flange joints. The ring includes an outer ring of a rigid plastic or metal material, an a deformable inner ring, of rubber or the like, having concentric first and second portions.

Nikirk et al., U.S. Pat. No. 5,511,797, disclose a tandem seal gasket assembly including a heat resistant outer seal on a profiled metal base ring. In one arrangement a first seal is defined be a PTFE envelope provided over the base ring, with a second seal being defined by a spiral wound gasket.

Jennings et al, U.S. Pat. No. 4,471,965, disclose a high pressure, fire resistant metal seal. The seal has a sealing lip with a round or curved sealing face, and a cylindrical metal surface against which the sealing lip abuts in a fluid-tight engagement.

Becerra, U.S. Pat. No. 5,421,594, discloses a pipe flange gasket having a core of a functionally corrugated material which is encapsulated within a graphite material.

Breaker, U.S. Pat. No. 5,427,386 discloses a protective seal which employs an intumescent material and a channeling structure for channeling the intumescent material into a separation gap caused by the thermal separation of adjacent pipe sections.

Metallic Gasket Handbook, Fluid Sealing Association, Philadelphia, Pa. (1979), and the Parker Seals Publications “Spirotallic® Spiral Wound Gaskets,” Parker Seal Group, Lexington, Ky. (1981), and “Parmite Spirotallic® Gaskets,” Parker Seal Group, Lexington, Ky. (1985), disclose various gasket arrangements comprising a metal retainer member and an compressible insert formed of a spiral wound metal strip material. Other spiral wound gasket constructions are shown in Goetze, U.S. Pat. No. 2,192,739; Palumbo et al., U.S. Pat. No. 2,882,083; McCreary, U.S. Pat. No. 2,339,479; Hoheisel, U.S. Pat. No. 2,339,478; Santoro, U.S. Pat. No. 2,269,486; and Bohmer, Jr., et al., U.S. Pat. No. 2,200,212.

Other pipe flange and composite gaskets are shown in Smith, U.S. Pat. No. 2,914,350; Moyers, U.S. Pat. No. 3,195,906; Carrell, U.S. Pat. No. 3,231,289; Tolman et al, U.S. Pat. No. 3,524,662; and U.K. Patent No. 126,244.

The above-described references heretofore have constituted the state of the art with respect to pipe flange seals and gaskets. However, for certain applications, particularly in the petroleum, chemical, and nuclear industries and in shipboard applications, there remains a need for flame and heat resistant pipe flange gaskets. In this regard, wherever machinery is present, there exists a risk of fire which is compounded by the presence of flammable or explosive fluids being conveyed through a piping system. In the event of a fire, the pipeline system may leak at elevated temperatures from thermal expansion at the flange joints. If the fluid itself is flammable or hazardous, there is presented both the risk of exposure to personnel and the risk that the fire may be accelerated and more difficult to contain.

Conventional gaskets of a flame resistant variety traditionally have employed spiral wound metal or graphite seal elements, sometimes in conjunction with an intumescent material. The spiral wound element typically is constructed of a thin, profiled metal strip which is wound into a spiral configuration within an interleaved strip of a sealing material such as PTFE, asbestos, or graphite. The intumescent material may be a graphite catalyzed polyurethane, silicone, polyester, or other such material that expands under the influence of elevated temperatures to form an thermally-protective, insulative layer.

In view of the foregoing, it is apparent that continued improvements in pipe flange gaskets, and particularly in the flame resistance thereof, gaskets would be well-received for use in original pipeline installations and for the retrofit of existing installations. A preferred gasket construction would be economical to manufacture, but also would exhibit reliable sealing performance even within fire conditions. Such a gasket additionally would be capable of providing fluid sealing with a minimum of compression set and resultant torque loss, and of withstanding prolonged exposure to hydrocarbons and other corrosive fluids within rigorous service environments.

### BROAD STATEMENT OF THE INVENTION

The present invention is directed to a sealing gasket particularly adapted for use between interface surfaces of an opposing pair of pipe flanges. The gasket includes a metal retainer member having an aperture which defines a fluid port opening, at least one annular, flame resistant outer seal members supported on the retainer as disposed concentrically with the port opening a spaced-apart radial distance therefrom, and, optionally, at least one annular, elastomeric inner seal member supported on the retainer as concentrically disposed intermediate the outer seal member and the port opening. Preferably, a registered pair of outer seal members are provided as each received within an corresponding outer mounting grooved formed within the opposing surfaces of the retainer, with the inner seal member being provided either as a like pair received with corresponding inner mounting grooves, or as a unitary member supported circumferentially about the inner peripheral surface of port opening.

Further in such preferred embodiment, the outer seal members are formed of a layer of a lamellar, expanded graphite sheet material, i.e., laminated foil, which is both flame resistant and compressible in a fluid-tight sealing arrangement to conform to asperities or other irregularities between the interface surfaces of the pipe flanges with a minimum of compression set. The compression of both the inner and outer seal members of the gasket advantageously is delimited to an optimum thickness by the thickness of the metal retainer member. The metal retainer additionally provides for direct metal-to-metal contact between the interface surfaces of the pipe flanges to accommodate the development of high tensile stresses, with a minimum of torque loss from thermal cycling, in the bolts or other fastening members used to couple the interface surfaces into a joint assembly.

Advantageously, with the inner seal members being protected in a flame environment by the outer seal, the inner seal members may molded or otherwise formed of a highly resilient material which may be selected specifically for high temperature performance or otherwise for compatibility with the fluid being handled. Should the elastomeric inner seal members eventually fail in the flame environment, however, the outer seal members afford a redundant sealing capability allowing the gasket to maintain its fluid integrity for an extended period of exposure.

It therefore is a feature of the present invention to provide a flame resistant gasket for interposition between the interface surfaces of a pair of mating pipe flanges. The gasket includes a metal retainer member having generally planar first and second surfaces with at least one aperture formed therethrough which is configured for generally coaxial registration with a fluid passageway defined through the pipe flanges. At least one generally annular, flame resistant outer seal member is supported on the retainer member as disposed coaxially with the aperture thereof a spaced-apart, radially outward distance therefrom. The outer seal member has oppositely-disposed first and second outer radial sealing surfaces for abutting contact with a corresponding one of the interfaces surfaces, and is compressible axially between the interface surfaces for effecting a first fluid-tight seal about the fluid passageway. At least one generally annular, elastomeric inner seal member optionally is attached to the retainer member as disposed coaxially with the aperture thereof radially inwardly of the outer seal member. The inner seal member has oppositely-disposed first and second inner radial sealing surfaces for abutting contact with a corresponding one of the interfaces surfaces, and is compressible axially between the interface surfaces for effecting a second fluid-tight seal about the fluid passageway.

It is a further feature of the invention to provide for the fluid-tight sealing of, for example, a pair of mating pipe flanges by interposing a flame resistant gasket between the interface surfaces of the pipe flanges. The gasket includes a metal retainer member having generally planar first and second surfaces with at least one aperture formed therethrough which is registered coaxial registration with a fluid passageway defined through the pipe flanges. At least one generally annular, flame resistant outer seal member is supported on the retainer member as disposed coaxially with the aperture thereof a spaced-apart, radially outward distance therefrom. The outer seal member has oppositely-disposed first and second outer radial sealing surfaces which abuttingly contact a corresponding one of the interfaces surfaces of the pipe flanges, and is compressed axially therebetween effecting a first fluid-tight seal about the fluid passageway. At least one generally annular, elastomeric inner seal member optionally is attached to the retainer member as disposed coaxially with the aperture thereof radially inwardly of the outer seal member. The inner seal member has oppositely-disposed first and second inner radial sealing surfaces which abuttingly contact a corresponding one of the interfaces surfaces of the pipe flanges, and is compressed axially therebetween effecting a second fluid-tight seal about the fluid passageway.

Advantages of the present invention include a composite sealing gasket which exhibits reliable sealing properties and torque retention with a minimum of compression set. Additional advantages include a gasket which is economical to manufacture, and which is capable of withstanding prolonged exposure to the high temperatures and thermal cyclings, high pressures, and fluids such as hydrocarbons found within rigorous service environments. Still further advantages include a gasket construction that has been observed to pass American Petroleum Institute (API) Standard 607 Fire Test at 1600° F. for 30 minutes. These and other advantages will be readily apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is a plan view of one embodiment of a flame resistant pipe flange gasket according to the present invention;

FIG. 2 is a cross-sectional view of the gasket of FIG. 1 taken through line 2-2 of FIG. 1;

FIG. 3A is a fragmentary, cross-sectional assembly view showing the gasket of FIG. 1 as interposed between the interface surfaces of a pair of connecting pipe flanges;

FIG. 3B is a fragmentary, cross-sectional view showing the gasket of FIG. 1 as compressed between the pipe flanges of FIG. 3A to develop a flame-resistant, fluid-tight seal therebetween;

FIG. 4 is a plan view of another embodiment of a flame resistant pipe flange gasket according to the present invention;

FIG. 5 is a cross-sectional view of the gasket of FIG. 4 taken through line 5-5 of FIG. 4;

FIG. 6 is a plan view of another embodiment of a flame resistant pipe flange gasket according to the present invention; and

FIG. 7 is a cross-sectional view of the gasket of FIG. 6 taken through line 7-7 of FIG. 6.

The drawings will be described further in connection with the following Detailed Description of the Invention.

### DETAILED DESCRIPTION OF THE INVENTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “inner,” or “inboard” and “outward,” “outer,” or “outboard” referring, respectively, to directions toward and away from the center of the referenced element, and the terms “radial” and “axial” referring, respectively, to directions perpendicular and parallel to the longitudinal central axis of the referenced element. Terminology of similar import other than the words specifically mentioned above likewise is to be considered as being used for purposes of convenience rather than in any limiting sense.

For the illustrative purposes of the discourse to follow, the precepts of the sealing gasket of the present invention are described in connection with the installation thereof between a pair of annular interface surfaces as may be presented from a mating pair of terminal pipe ends. As is known in the art, each of the mating pipe ends conventionally may be provided as including an annular flange that extends radially outwardly about a central fluid port opening of each pipe to define an interface surface which is oriented generally perpendicularly to the central longitudinal axis of the pipe. With these interface surfaces disposed in confronting opposition, the fluid port openings thereof are registered in fluid communication registration to define a fluid passageway through the pipes. The flanges may be secured with a clamp or with a plurality of bolts or other fastening members received through registered pairs of openings spaced circumferentially about the flanges. In view of the discourse to follow, however, it will be appreciated that aspects of the present invention may find utility in other fluid sealing applications requiring a flame resistant joint wherein a pair of mating interface surfaces. Such surfaces may include manifolds through which a plurality of fluid passageways are provided. Use within those such other applications therefore should be considered to be expressly within the scope of the present invention.

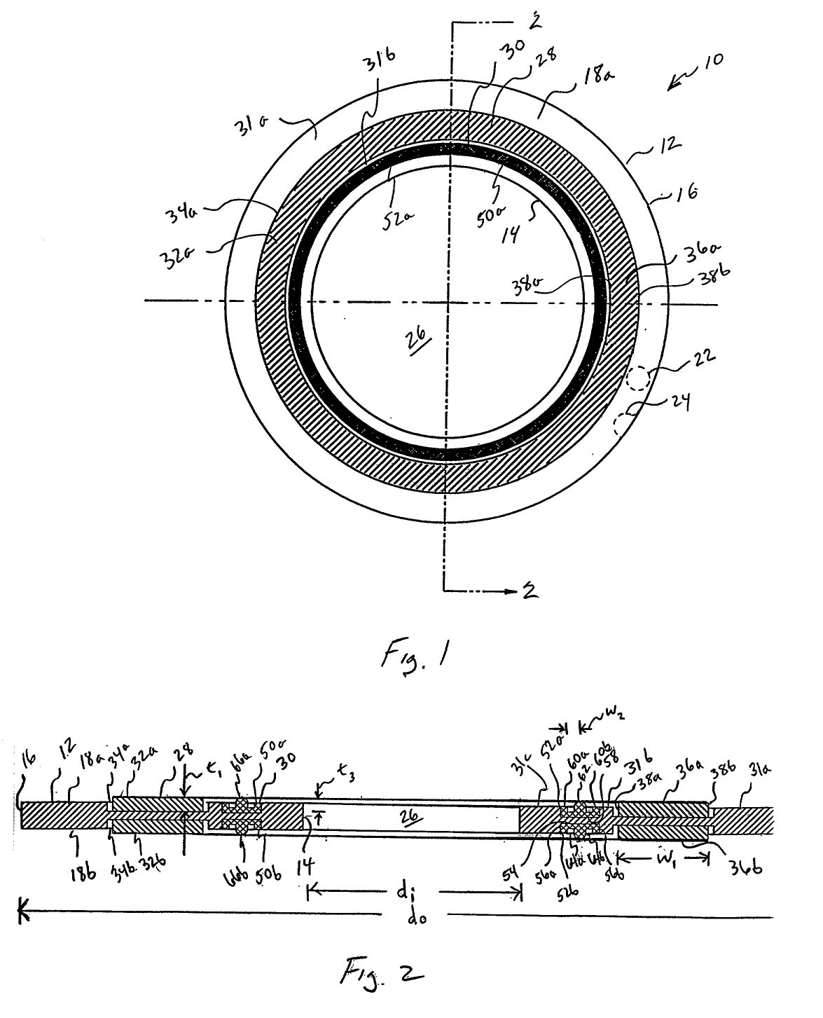

Referring then to the figures wherein corresponding reference characters are used to designate corresponding elements throughout the several views, shown generally at 10 in FIGS. 1 and 2 is a representative embodiment according to the present invention of a flame resistant gasket or seal configured for interposition and compression between the annular interface surfaces of a mating pair of annular pipe end flanges to effect a fluid-tight sealing thereof. In this regard, gasket 10 includes a generally planar metal retainer member, 12, which is configured as having circular inner and outer peripheries, 14 and 16, respectively, which define annular first and second radial surfaces, 18a and 18b (FIG. 2), respectively, therebetween. The outer periphery 16 of retainer member 12 may be sized, as is shown at dₒ, to be of an outer diametric extent which is receivable intermediate the fastening members of the pipe flanges. That is, outer periphery 16 of retainer member 12 may be sized for registration between the fastening members of the flanges.

Alternatively, depending upon the configuration of the flanges, retainer member 12 may be formed as having an outer periphery 16 of margins which correspond to the outer geometry of the interface surfaces to be sealed. In such embodiment, for locating and aligning the gasket 10 within the joint, retainer member 12 additionally may be formed including a plurality of bolt holes, one of which is shown in phantom at 22 in FIG. 1 as disposed along a bolt circle, or peripheral notches, one of which is shown in phantom at 24. Such holes 22 or notches 24 may be employed for receiving the bolts or other fasteners which are conventionally employed for coupling the associated connecting flanges under a predetermined amount of torque. Advantageously, holes 22 or notches 24 provide a positive stop delimiting the compression of the gasket to thereby avoid the over-compressed thereof during installation or maintenance.

The inner periphery 14 of retainer member 12, in turn, defines a central aperture, shown at 26, which is configured for generally coaxial registration with the fluid passageway defined through the mating pipe flange ends. Preferably, aperture 26 is sized, as is shown at d₁, to be of an inner diametric extent which is greater than the inner diameter of the corresponding fluid passageway. In this way, an additional pressure drop need not be introduced into piping system. It will be appreciated, however, that the configuration of the outer periphery 16 of the retainer member 12, as well as the number, arrangement, and geometry of aperture 26, may vary depending, respectively, upon the configuration, number, or arrangement of the fluid passageways or the interface surfaces of the associated connecting flange assembly. Irrespective of its configuration, retainer member 12 may be formed as a metal stamping with one or more apertures 26 being die cut therein. Metal materials suitable for the construction of retainer member 12 include aluminum, steel, stainless steel, copper, brass, titanium, nickel, and alloys thereof, with low carbon steel being economical and thereby preferred for many applications.

In accordance with the precepts of the present invention, gasket 10 further includes at least one flame resistant outer seal member, 28, and at least one elastomeric inner seal member, 30. As may be seen best in the cross-sectional view of FIG. 2, outer seal member 28 is supported on retainer member 12 as circumscribing aperture 26. That is, outer seal member 28 is disposed coaxially with aperture 26 a spaced-apart, radially outward distance therefrom and a spaced-apart radial inward distance from the outer periphery 16 of retainer member 12. In this regard, a first and second backup portion, 31a-b, of retainer member 12 advantageously is defined for supporting the outer seal member and reducing the potential for damage thereto during installation or replacement.

Further with respect to the illustrated gasket embodiment, outer seal member 28 is provided as comprising first and second outer seal elements, 32a-b, insertably received or adhesively bonded within an axially registered pair of outer mounting grooves, 34a-b, each of which is machined or otherwise recessed into a respective radial surface 18 of retainer member 12. Preferably, each of grooves 34, which likewise are disposed coaxially with aperture 26 a spaced-apart, radial outward distance therefrom, are formed to define a generally U-shaped channel of a cross-section configured to receive an outer seal element 32. Each seal element 32 may be correspondingly shaped to have a general rectangular, axial cross-section but, in order to accommodate the compressive deformation thereof, preferably are sized to be of a radial width, referenced at w₁, which is marginally smaller than the width of the corresponding groove 34. Typically, such width w₁ will be between about ¼ to ½-inch, with grooves 34 being between about 10% larger than the width w₁. In this regard, the tolerances between the seal element and channel widths need not be especially close as the compression of seal member 28 between the interface surfaces of the pipe ends will, in operation, hold the elements in place within the corresponding mount groove 34. To facilitate the installation of the gasket, however, the seal elements seal member may be adhesively bonded within the grooves using, for example, a rubber-based contact cement, although a higher-temperature adhesive, such as a silicone, may be substituted.

Within grooves 34, seal elements 32 present oppositely disposed, generally annular surfaces, 36a-b, which extend between the inner and outer diametric extents, 38a-b, thereof to define a first and a second outer radial sealing surface of the gasket 10. Although surfaces 36 each are shown in FIG. 1 to be of the same, circular or ring-shaped geometry for generally coaxial registration with a generally tubular fluid flow passageway, it will be appreciated that different and/or independent geometries of surfaces 36 may be envisioned depending upon the configuration of the corresponding passageway and/or interface surfaces of the pipe ends. Moreover, the inner diametric extent 38a of the seal elements 32 may be of the same geometry, as is shown, or of a different geometry as the outer diametric extent 38b, again as depending upon the configuration of the corresponding passageway and/or interface surfaces of the pipe ends.

For the axial compression of seal member 28 between the interface surfaces of the pipe flanges effecting a first, outer fluid-tight seal about the fluid passageway, surfaces 36 may be provided, depending upon the geometry of the interface surfaces, to extend beyond the corresponding radial surface 18 of retainer member 12 for abutting contact with a corresponding one of the interface surfaces of the pipe flanges. That is, each of seal elements 32 may be provided, as is shown in FIG. 2, to have a nominal axial cross-sectional thickness, referenced at t₁, that is from about 1-35 mils more than the nominal axial depth of the corresponding groove 34 of retainer member 12. Depending upon its material of construction, retainer member 12 typically will be provided as having a thickness, t₂, of from about 1/16-½ inch.

In accordance with the precepts of the present invention, outer seal member 28 is provided to be formed of a flame resistant material. As used herein, “flame resistant” means that gasket 10 is intended to maintain the fluid-tight integrity of the associated joint for a predetermined period of time, generally from about 5-30 minutes, upon the exposure of the gasket to a flame source other otherwise to elevated temperatures of between about 1400-1600° F. In this regard it is preferred that each of seal elements 32 are provided to be formed of a flexible layer of an expanded graphite sheet material which is compressible axially between the interface surfaces of the pipe flanges for effecting a flame resistant, first fluid-tight seal about the corresponding fluid passageway of the pipe ends. Such material is formed as a consolidated laminate of a plurality of mechanically-interlocked, thin graphite foil sheets. By “compressible,” it is meant that the material may be compacted under force by about 20-50% in axial thickness from an uncompressed density of about 50-90 lb/ft³ to a compressed density of about 95-125 lb/ft³. Advantageously, such material, which is also known as “flexible graphite,” exhibits the thermal stability and chemical resistance of graphite, as well as the complementary properties of flexibility, compactability, conformability, and resilience. In particular, the resilient behavior of the material, which is characterized as exhibiting a recovery, i.e., hysteresis or “spring-back,” to a thickness which is between its no-load and under-load thickness. Such behavior, in conjunction with a low creep relaxation maintaining a prescribed compressive load under service pressure with minimal compression set, provides an effective sealing material having an inherent stability under a wide temperature range. The lamellar graphite sheet material of the type herein involved is described further in U.S. Pat. No. 3,404,061, and in “Flexible Graphite Non-Asbestos Gasketing Material,” UCAR Carbon Company, Inc., paper presented at the Asbestos Substitute Gasket & Packing Materials Seminar, Aug. 6-7, 1986, Houston, Tex. The material is marketed commercially under the name “GRAFOIL®” by UCAR Carbon Company, Parma, Ohio. Individual seal elements 32 may be fabricated by die-cutting sheets of the laminate to the thickness of the final part. Alternatively, the individual elements may be formed in a mold to a net-shaped part.

As may be seen best in FIG. 2, elastomeric inner seal member 30 is supported on retainer member 12 as circumscribing aperture 26, but as disposed radially inwardly of outer seal member 28. That is, inner seal member 30 is disposed coaxially with aperture 26 as interposed between aperture 26 and outer seal member 28. In the illustrated embodiment, inner seal member 30 is shown to be spaced-apart radially from aperture 26 and outer seal member 28 to define a third backup portion, 31c, of retainer member 12 which together with the second backup 31b portion thereof supports the inner seal member and reduces the potential for damage thereto during installation, replacement, or exposure to high hydrostatic pressures.

As was flame resistant outer seal member 28, elastomeric inner seal member 30 similarly may be provided as comprising first and second inner seal elements, 50a-b, disposed within an axially registered pair of inner mounting grooves, 52a-b, each of which is machined or otherwise recessed into a respective radial surface 18 of retainer member 12. Preferably, and as may be seen best in FIG. 2, each of grooves 52, which are disposed coaxially with aperture 26 radially inwardly of outer mounting grooves 34, each are formed to define a generally U-shaped channel including a base wall, 54, and parallel lateral walls, 56a-b. Each seal element 50, as is shown for element 50a, may be correspondingly shaped to include a base portion, 58, and parallel lateral portions, 60a-b, and further to include a central bead or lobe portion, 62, which is radially spaced-apart from the lateral portions 60 to define a pair of annular void portions, 64a-b. Bead portions 62 may be of any radial size, but typically will have a width, w₂, which, depending upon the size of the groove 52, is between about 0.030-0.125 inch.

Within grooves 52, the bead portions 62 of seal elements 50 present oppositely disposed, generally hemispherical surfaces, 66a-b, which define a first and a second inner radial sealing surface of the gasket 10. Seal elements 50 are shown in FIG. 1 extend about the same circular periphery for generally coaxial registration with a generally tubular fluid flow passageway, it will be appreciated, however, that different and/or independent geometries of seal elements 50 may be envisioned depending upon the configuration of the corresponding passageway and/or interface surfaces of the pipe ends.

For the axial compression of seal member 30 between the interface surfaces of the pipe flanges effecting a second, inner fluid-tight seal about the fluid passageway, the bead portions 60 of seal elements 50 may be provided, depending upon the geometry of the interface surfaces, to extend beyond the corresponding radial surface 18 of retainer member 12 for abutting contact with a corresponding one of the interface surfaces of the pipe flanges. That is, bead portions 60 may be provided, as is shown in FIG. 2, to have a nominal axial cross-sectional thickness, referenced at t₃, that is from about 10-55 mils more than the nominal axial depth of the corresponding groove 52 of retainer member 12. With void portions 64 being provided to accommodate the deformation of bead portions 60, the surfaces 66 thereof may lie coplanarly with retainer surfaces 18 when seal member 30 is compressively energized between the interface surfaces of the pipe flanges.

As aforementioned, retainer member 12 may be formed as a metal stamping with grooves 34 and 52 being stamped or machined. For the attachment of elastomeric seal elements 50 to the base and lateral walls 54 and 56 of grooves 52, the inner surfaces thereof may be primed with a bonding agent such as Chemloc™ 607 (E. V. Roberts & Associates, Culver City, Calif.). The primed retainer 12 then may be placed into a heated molded cavity for the injection, compression, or transfer molding of an uncured rubber compound forming the integral seal elements. Each of the elastomeric elements thereby may be formed and cured-in-place as vulcanized directly onto retainer member 12. Alternatively, the elastomeric elements may be molded in a separate operation and bonded to retainer member 12 using an adhesive or the like.

Elastomeric elements 50 preferably are formed of a synthetic rubber, specifically as selected for high temperature performance or otherwise for compatibility with the fluid being handled. Suitable materials include thermoplastic or thermosetting synthetic rubbers such as fluorocarbon, SBR, polybutadiene, EPDM, butyl, neoprene, nitrile, polyisoprene, silicone, fluorosilicone, buna-N, copolymer rubbers, or blends such as ethylene-propylene rubber. As used herein, the term “elastomeric” is ascribed its conventional meaning of exhibiting rubber-like properties of compliancy, resiliency or compression deflection, low compression set, flexibility, and an ability to recover after deformation, i.e., stress relaxation.

Advantageously, both seal members 28 and 30 exhibit a reduced yield stress as compared to metal retainer member 12 and, accordingly, are deformable for conforming to any irregularities between the interface surfaces of the pipe flanges. As will be more fully appreciated hereinafter, as a given compressive load is applied by the tightening of the bolts which mat be used to fasten the interface surfaces of the flange assemblies, an increased bearing stress is provided about the fluid passageway of the pipes by virtue of the reduced surface area contact of the bearing surfaces 36 and 66 of the seal members on the interface surfaces. This increased stress is sufficient to exceed the reduced yield stress of the seal members for the deformation thereof effecting the fluid-tight sealing of the corresponding fluid passageway.

It has been observed that the provision of inner seal member 30 advantageously facilitates the installation and replacement of gasket 10 in accommodating for tolerances or other minor differences in the torque load of the bolts or other fastening members conventionally employed to join the respective pipe flange ends. That is, by virtue of the resiliency of elastomeric inner seal member 30, the fluid integrity of the gasket 10 may be maintained to some degree even if the joint spacing between the flanges is less than exactly uniform. The provision of inner elastomeric seal member 30, moreover, may be used to develop a hermetic seal which is especially useful in petrochemical and other applications to control the fugitive emission of VOC's and other pollutants.

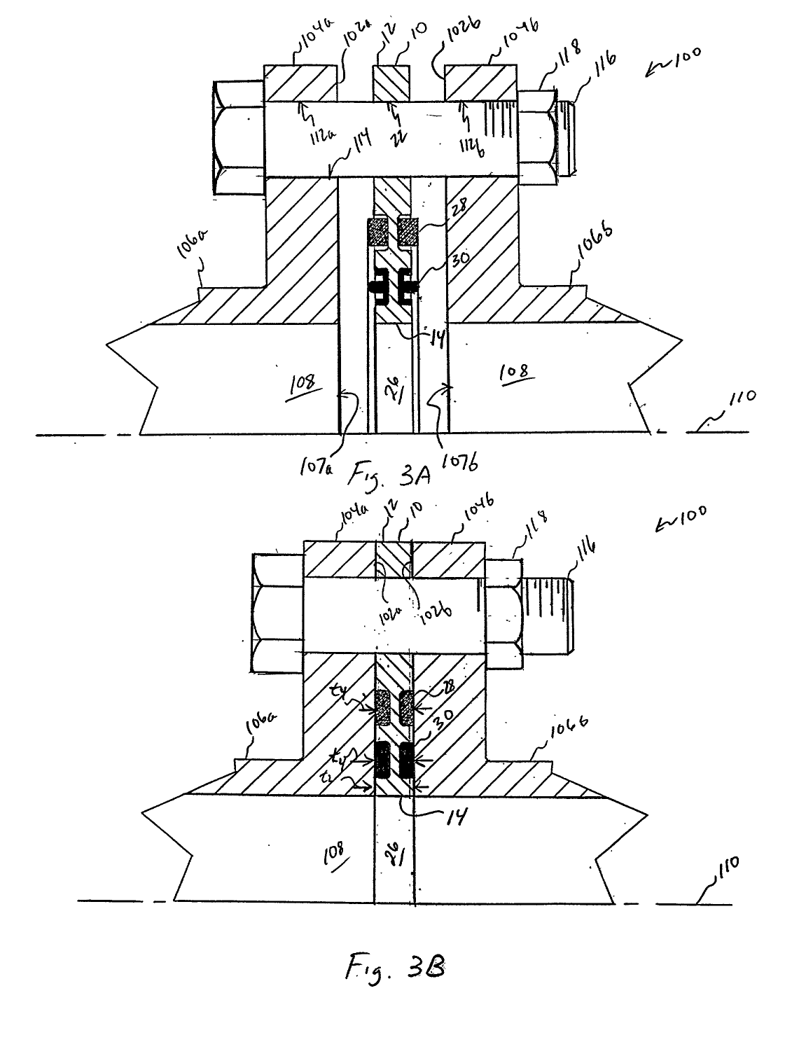

Referring then to FIG. 3A, shown generally at 100 is an cross-sectional, assembly view of a representative pipe flange joint assembly. Within joint assembly 100, gasket 10 of the present invention is shown as interposed between a pair of mutually-facing, axially spaced-apart interfaces surfaces, 102a-b, which are presented by the corresponding connecting flanges, 104a-b, of a mating pair of pipe ends, 106a-b. Each of the interface surfaces 102 is formed as having at least one fluid port opening, referenced respectively at 107a-b, disposed in registration with a corresponding one of the fluid ports of the other interface surface for defining a fluid passageway, reference at 108, of the exhaust system. Fluid passageway 108 is of a nominal inner diameter and extends along a longitudinal axis 110 through pipes 106. Gasket 10 is disposed between the interface surfaces 102 with aperture 26 in general coaxial registration with the corresponding fluid passageway 108.

Additionally defined within each of interface surfaces 102 are plurality of bores, one of which is referenced at 112a for flange 104a and at 112b for flange 104b, disposed adjacent fluid passageway 108. Each of the bores 112 of each flange 104 is in alignment with a corresponding bore of the other flange 104 to define a hole, one of which is referenced at 114, configured to receive an associated fastening member, which is illustrated as a threaded bolt, 116, having an associated nut, 118. Bolts 116 connect flanges 104 and may be tightened to a predetermined torque to effect the compression of gasket 10 in a sealing engagement between interface surfaces 102. In this regard, and as was aforementioned, retainer member 12 additionally may be configured to include a plurality of bolt holes for the alignment of the gasket between the flanges. As is shown in FIG. 3A for the bolt hole referenced at 22, each of these holes is disposed about a bolt circle for coaxial registration with a corresponding one of the fastener member holes 114 for receiving one of the fastener members 116 therethrough.

Continuing with FIG. 3B, upon the tightening of bolts 116 and nuts 118 to a predetermined torque, seal members 28 and 30 may be compressed between interface surfaces 102 to a thickness, referenced at t₄, which is equal to the thickness t₂ of retainer member 12. It will be appreciated that the inner periphery 14 of retainer member 12 is sized such that aperture 26 thereof preferably is positioned to extend coterminously with or otherwise radially outwardly of the inner diameter of fluid passageway 108 so as not to introduce an additional pressure drop through the passageway although ensuring a continuous, fluid-tight sealing thereof.

The combination of a metal retainer member 12 and compressible seal members 28 and 30 advantageously provides a gasket construction which minimizes torque loss and thereby obviates much of the need for the periodic retorquing of the fastening members of the joint. That is, it is well-known that gaskets of the type herein involved are prone to developing a compression set which is manifested by fluid leaks as the tension in the bolts is relaxed and the fluid-tight sealing of the fluid passageways is compromised. In this regard, the provision of seal members 28 and 30 ensures the positive and redundant sealing of the fluid passageway, with metal retainer member 12, in turn, synergistically providing metal-to-metal contact in establishing an alternative load torque path minimizing the compression set and leak potential of the gasket. The metal-to-metal contact provided by retainer member 12 additionally affords improved heat transfer between the interface surfaces of the pipe flanges, and also develops relatively high seal stresses for the fluid-tight sealing of the fluid passageway.

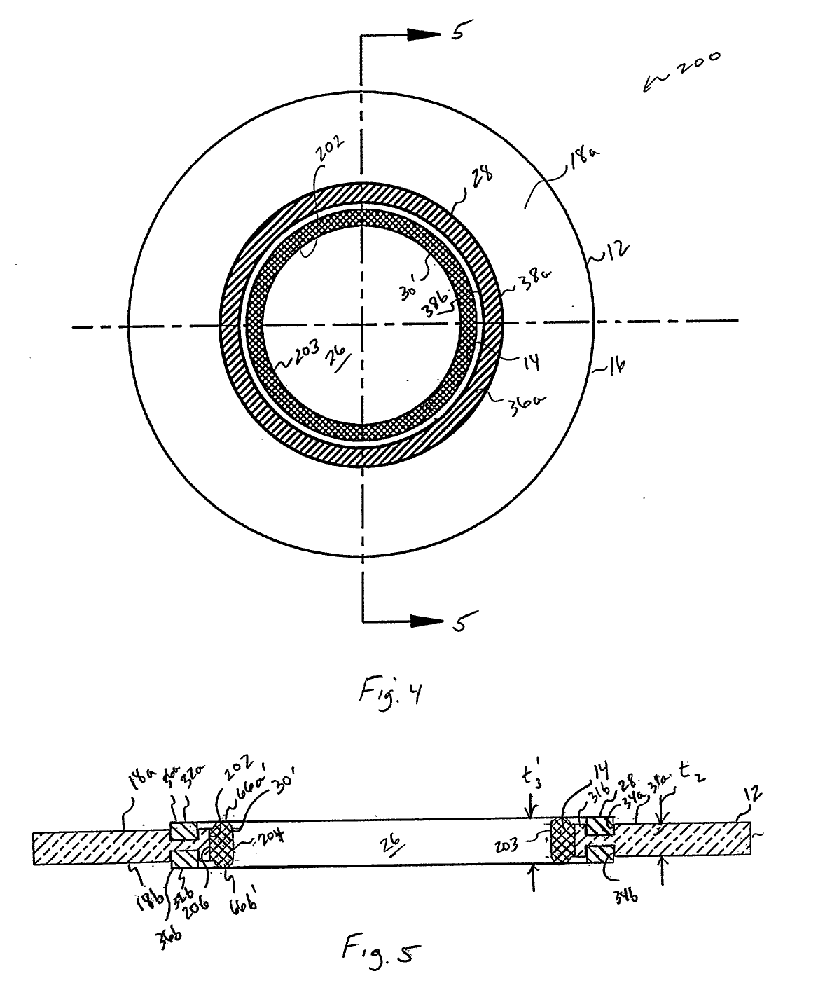

Looking next to FIGS. 4 and 5, another representative embodiment of gasket 10 of the present invention is shown generally at 200 wherein elastomeric inner seal member 30 is provided, as is shown at 30′, as attached to the inner peripheral surface, 202, of aperture 26. In such embodiment, inner seal member 30′, which may be configured as having a generally elliptical cross-section, includes an outboard side, 204, which is attached to peripheral surface 202 and an inboard side, 206, which defines the inner periphery, 203, of gasket 10 and aperture 26 thereof.

As attached to peripheral surface 202, seal member 30′ presents oppositely disposed, generally hemispherical bearing surfaces, 66a′-b′, which define the first and a second inner radial sealing surface of the gasket 200. Accordingly, the inner periphery of 14 of retainer member 12 is sized to further extend outwardly of the inner diameter of fluid passageway 108 (FIG. 3) such that the bearing surfaces 66′ are disposed for abutting contact with a corresponding one of the interface surfaces of the pipe flanges for the axial compression of seal member 30′ therebetween effecting the second, inner fluid-tight seal about the fluid passageway. As before, seal element 30′ may be provided, depending upon the geometry of the interface surfaces, to extend beyond the corresponding radial surface 18 of retainer member 12 in having a nominal axial cross-sectional thickness, referenced at t₃′, that is from about 1-100 mils more than the axial thickness t₂ of the retainer member 12. Although the aperture 26 is shown in FIGS. 3 and 4 to have a generally circular geometry, other closed geometries such as polygonal, elliptical, and the like again may be substituted without departing from the scope of the invention herein involved.

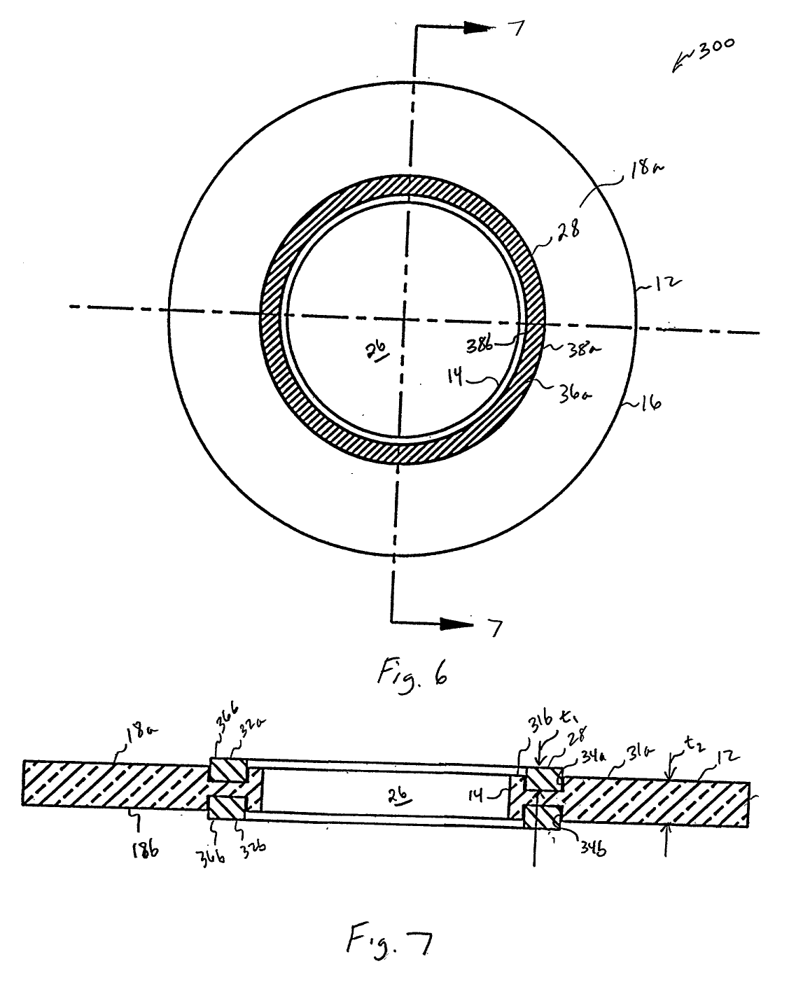

Referring lastly to FIGS. 6 and 7, another representative embodiment of gasket 10 of the present invention is shown generally at 300 wherein the elastomeric inner seal member 30 or 30′ is eliminated to provide a generally continuous second backup portion 31b of retainer member 12 extending radially intermediate the inner periphery 14 thereof and outer mounting grooves 34. As in the other gasket embodiments illustrated herein, the retention of the outer seal elements within grooves 34 advantageously confines the elements and thereby, during deformation under load, minimizes the extrusion thereof which otherwise could compromise the integrity of the fluid seal.

The example which follows is illustrative of the advantages of the present invention, but should not be construed in a limiting sense.

### EXAMPLE

To confirm the precepts of the present invention a 1-inch pipe flange gasket, constructed in accordance with FIGS. 1 and 2 hereinabove as including expanded graphite foil outer seal elements and molded-in rubber inner seal elements, was subjected to leakage testing by Omega Point Laboratories, Inc., Elmendorf, Tex., in accordance with American Petroleum Institute (API) Standard 607 Fire Test For Soft-Seated Quarter-Turn Valves (modified). The test encompassed pressurizing the gasket with water from a source tank, and exposing the gasket to a hydrocarbon temperature curve as specified in the standard. During the test, leakage was measured by monitoring the water level in the source tank, and then calculating the volume change over time. The following leakage (Lkg) results were recorded:

TABLE 1
(API) Standard 607 Fire Test Results

| Lkg @ | | | Avg. Lkg. |
|---|---|---|---|
| 212° F. | Lkg @ | Avg. Lkg Rate Over | Rate Over |
| (ml) | 40:00 min. (ml) | Time to 212° F. (ml/min) | 40 min. (ml/min) |
| 0 | 1.622 | 0 | 40.6 |

The standard specifies that the total leakage should be determined when the specimen temperature falls below 212° F., with the allowable leakage rate under the standard for the 1-inch specimen tested being 25 ml/min. As the specimen tested did not exhibit any measurable leakage over the designated test period of 0-33 minutes, it was concluded that the specimen met the requirements of the standard.

Thus, a unique, metal and graphite combination gasket construction for pipe flanges and other applications is described which develops metal-to-metal contact for maintaining high bolt tension. Such construction additionally provides for good seal recovery even at relatively high temperatures.

As it is anticipated that certain changes may be made in the present invention without departing from the precepts herein involved, it is intended that all matter contained in the foregoing description shall be interpreted in as illustrative rather than in a limiting sense. All references cited herein are expressly incorporated by reference.

What is claimed is:

1. A flame resistant gasket for interposition between a pair of mutually-facing, axially spaced-apart interface surfaces, each of the interface surfaces having at least one fluid port disposable in fluid communication registration with a corresponding fluid port of the other interface surface for defining a fluid passageway therethrough, said assembly comprising:
a metal retainer member having generally planar first and second surfaces with at least one aperture formed therethrough, said aperture being configured for generally coaxial registration with the fluid passageway and having a inner peripheral surface; and
at least one generally annular, flame resistant outer seal member supported on said retainer member as disposed coaxially with said aperture a spaced-apart, radially outward distance therefrom, said outer seal member having oppositely-disposed first and second outer radial sealing surfaces for abutting contact with a corresponding one of the interfaces surfaces, and being compressible axially between the interface surfaces for effecting a first fluid-tight seal about the fluid passageway.

2. The gasket of claim 1 wherein said outer seal member is formed of a layer of a lamellar graphite sheet material.

3. The gasket of claim 1 wherein said retainer member is constructed of a metal material selected from the group consisting of aluminum, steel, stainless steel, copper, brass, titanium, nickel, and alloys thereof.

4. The gasket of claim 1 wherein the first surface of said retainer member is formed as having a generally annular first outer mounting groove disposed coaxially with said aperture a spaced-apart, radially outward distance therefrom, and the second surface of said retainer member is formed as having a generally annular second outer mounting groove disposed coaxially with said aperture as aligned in axial registration with said first mounting groove, and wherein said outer seal member is provided as comprising a first and a second outer seal element, each said outer seal element being received within a corresponding said outer mounting groove of said retainer member.

5. The gasket of claim 1 further comprising at least one generally annular, elastomeric inner seal member attached to said retainer member as disposed coaxially with said aperture radially inwardly of said outer seal member; said inner seal member having oppositely-disposed first and second inner radial sealing surfaces for abutting contact with a corresponding one of the interfaces surfaces, and being compressible axially between the interface surfaces for effecting a second fluid-tight seal about the fluid passageway.

6. The gasket of claim 5 wherein said inner seal member is formed of a natural or synthetic rubber.

7. The gasket of claim 5 wherein each said inner seal element is formed as including a central bead portion which defines the corresponding said first and second inner radial sealing surfaces of said inner seal member.

8. The gasket of claim 4 further comprising at least one generally annular, elastomeric inner seal member attached to said retainer member as disposed coaxially with said aperture radially inwardly of said outer seal member; said inner seal member having oppositely-disposed first and second inner radial sealing surfaces for abutting contact with a corresponding one of the interfaces surfaces, and being compressible axially between the interface surfaces for effecting a second fluid-tight seal about the fluid passageway.

9. The gasket of claim 8 wherein the first surface of said retainer member is further formed as having a generally annular first inner mounting groove disposed coaxially with said aperture radially inwardly of said first outer mounting groove, and the second surface of said retainer is formed as having a generally annular second inner mounting groove disposed radially inwardly of said second outer mounting groove as aligned in axial registration with said first mounting groove, and wherein said inner seal member is provided as comprising a first and a second inner seal element, each said inner seal element being received within a corresponding said inner mounting groove of said retainer member.

10. The gasket of claim 9 wherein each said inner mounting groove is spaced a predetermined, radially outward distance from said aperture.

11. The gasket of claim 5 wherein said inner seal member is attached to the inner peripheral surface of said aperture.

12. A flame resistant joint assembly comprising:
a first interface surface surrounding a first fluid port;
a second interface surface surrounding a second fluid port, said second interface surface being disposed in opposition with said first interface surface an axial spaced-apart distance therefrom with said second fluid port being aligned in fluid communication registration with said first fluid port to define a fluid passageway therethrough; and
a gasket interposed between said first and second interface surfaces, said gasket comprising:
a metal retainer member having generally planar first and second surfaces with at least one aperture formed therethrough, said aperture being registered coaxially with said fluid passageway and having a inner peripheral surface; and
a generally annular, flame resistant outer seal member supported on said retainer member as disposed coaxially with said aperture a spaced-apart, radially outward distance therefrom, said outer seal member having oppositely-disposed first and second outer radial sealing surfaces each abuttingly contacting a corresponding one of the interfaces surfaces of said first and said second flange, and being compressed axially therebetween effecting a first fluid-tight seal about said fluid passageway.

13. The joint assembly of claim 12 wherein said outer seal member of said gasket is formed of a layer of a lamellar graphite sheet material.

14. The joint assembly of claim 12 wherein said retainer member of said gasket is constructed of a metal material selected from the group consisting of aluminum, steel, stainless steel, copper, brass, titanium, nickel, and alloys thereof.

15. The joint assembly of claim 12 wherein the first surface of said retainer member of said gasket is formed as having a generally annular first outer mounting groove disposed coaxially with said aperture a spaced-apart, radially outward distance therefrom, and the second surface of said retainer member is formed as having a generally annular second outer mounting groove disposed coaxially with said aperture as aligned in axial registration with said first mounting groove, and wherein said outer seal member of said gasket is provided as comprising a first and a second outer seal element, each said outer seal element being received within a corresponding said outer mounting groove of said retainer member.

16. The joint assembly of claim 12 wherein said gasket further comprises a generally annular, elastomeric inner seal member attached to said retainer member as disposed coaxially with said aperture radially inwardly of said outer seal member; said inner seal member having oppositely-disposed first and second inner radial sealing surfaces each abuttingly contacting a corresponding one of the interfaces surfaces of said first and said second flange, and being compressed axially therebetween effecting a second fluid-tight seal about said fluid passageway.

17. The joint assembly of claim 16 wherein said inner seal member of said gasket is formed of a natural or synthetic rubber.

18. The joint assembly of claim 16 wherein each said inner seal element is formed as including a central bead portion which defines the corresponding said first and second inner radial sealing surfaces of said inner seal member.

19. The joint assembly of claim 15 wherein said gasket further comprises a generally annular, elastomeric inner seal member attached to said retainer member as disposed coaxially with said aperture radially inwardly of said outer seal member; said inner seal member having oppositely-disposed first and second inner radial sealing surfaces each abuttingly contacting a corresponding one of the interfaces surfaces of said first and said second flange, and being compressed axially therebetween effecting a second fluid-tight seal about said fluid passageway.

20. The joint assembly of claim 19 wherein the first surface of said retainer member of said gasket is further formed as having a generally annular first inner mounting groove disposed coaxially with said aperture radially inwardly of said first outer mounting groove, and the second surface of said retainer is formed as having a generally annular second inner mounting groove disposed radially inwardly of said second outer mounting groove as aligned in axial registration with said first mounting groove, and wherein said inner seal member of said gasket is provided as comprising a first and a second inner seal element, each said inner seal element being received within a corresponding said inner mounting groove of said retainer member.

21. The joint assembly of claim 20 wherein each said inner mounting groove is spaced a predetermined, radially outward distance from said aperture.

22. The joint assembly of claim 16 wherein said inner seal member is attached to the inner peripheral surface of said aperture.
